(19) United States
(12) Patent Application Publication
(10) Pub. No.: US 2013/0314404 A1
(43) Pub. Date: Nov. 28, 2013

(54) METHOD AND APPARATUS FOR ANALYZING STEREOSCOPIC OR MULTI-VIEW IMAGES

(71) Applicant: THOMSON LICENSING, Issy de Moulineaux (FR)

(72) Inventors: Joern JACHALSKY, Wennigsen (DE); Andrej Schewzow, Hannover (DE)

(73) Assignee: THOMSON LICENSING, Issy de Moulineaux (FR)

(21) Appl. No.: 13/897,418

(22) Filed: May 19, 2013

(30) Foreign Application Priority Data
May 24, 2012 (EP) 12305572.5

(51) Int. Cl. G06T 15/00

(52) U.S. Cl. CPC G06T 15/00
USPC 345/419

(57) ABSTRACT

A method and an apparatus for analyzing stereoscopic or multi-view images are described. A two-dimensional map associated to the stereoscopic or multi-view images is retrieved and segmented into a plurality of tiles. Then an analysis of the tiles of the two-dimensional map is performed. An analysis result for the two-dimensional map is determined from results of the analysis of the tiles of the two-dimensional map.

### FIELD OF THE INVENTION

The present invention relates to a method and an apparatus for analyzing stereoscopic or multi-view images. More specifically, a method and an apparatus for a pixel- or region-based analysis of stereoscopic or multi-view images are described, which are robust against outliers in the images.

### BACKGROUND OF THE INVENTION

In recent years stereoscopic 3D content for both theatrical and home entertainment has become increasingly popular. To create a sustainable and long-lasting trend, it is vital to ensure a quality and comfortable 3D experience for the end consumer in the cinema or at home. Thus, the content that is delivered to the end consumer has to meet certain minimum quality requirements with respect to the technical aspects of stereoscopic content production, such as feature films for theatrical release or broadcast.

For the technical quality analysis of the stereoscopic content, the analysis of the corresponding disparity maps plays an integral role. This allows for detection of hyperconvergence or hyperdivergence problems, edge conflicts, or alignment errors, e.g. vertical misalignments. To easily and accurately detect such problems, conflicts, or errors, it is necessary to utilize an automated analysis relying on robust and reliable algorithms and evaluation schemes.

The analysis of disparity maps for technical quality analysis is likewise applicable to multi-view content. Moreover, not only disparity maps associated to the stereoscopic or multi-view content may be analyzed. It is just as well possible to perform other types of image analysis that create pixel- or region-based incidents.

### SUMMARY OF THE INVENTION

It is an object of the present invention to propose a solution for analyzing stereoscopic or multi-view images for a technical quality analysis.

According to the invention, this object is achieved by a method for analyzing stereoscopic or multi-view images, which comprises the steps of:
retrieving a two-dimensional map associated to the stereoscopic or multi-view images;
segmenting the two-dimensional map into a plurality of tiles;
performing an analysis of the tiles of the two-dimensional map; and
determining an analysis result for the two-dimensional map from results of the analysis of the tiles of the two-dimensional map.

Similarly, an apparatus for analyzing stereoscopic or multi-view images comprises:
an input for retrieving a two-dimensional map associated to the stereoscopic or multi-view images;
a segmenter for segmenting the two-dimensional map into a plurality of tiles;
an analyzer for performing an analysis of the tiles of the two-dimensional map; and
a comparator for determining an analysis result for the two-dimensional map from results of the analysis of the tiles of the two-dimensional map.

The general idea of the invention is to segment a dense two-dimensional map into tiles, i.e. to create a tile grid. The two-dimensional map may be a disparity map, a confidence map, one of the stereoscopic or multi-view images or a reduced version thereof, etc. For each tile a separate analysis of the map values is performed, e.g. a histogram-based analysis. The results of each analysis are gathered, e.g. using counters, for an overall evaluation to generate the final analysis result for the complete map. The horizontal tile size, the vertical tile size, one or more thresholds for detecting or confirming incidents within the tiles, as well as further analysis parameters are determined based on the downscaling factor that was used to downscale the underlying stereoscopic images prior to the generation of the two-dimensional map. This allows for achievement of a scale-invariant analysis.

Preferably, it is determined whether the analysis of one or more tiles of the two-dimensional yielded an incident. The number of tiles for which the analysis yielded an incident is then compared with a threshold. If the number of tiles for which the analysis yielded an incident exceeds the threshold, it is determined that the stereoscopic or multi-view images do not pass the analysis.

The segmentation into tiles and the subsequent analysis on tile level makes the overall analysis robust against outliers and spatially disconnected threshold violations that are spread across the two-dimensional map. Only violations, which are in a certain spatial proximity, are detected. This ensures, at least in a first approximation, that only contiguous violations covering a certain part or spot having a minimum size of the two-dimensional map are marked as quality criterion violations.

Advantageously, it is determined whether the analysis of one or more tiles of the two-dimensional map failed and the number of tiles for which the analysis failed is compared with a threshold. If the number of tiles for which the analysis failed exceeds the threshold, it is determined that the analysis of the two-dimensional map failed. The evaluation of a tile may fail, for example, if the tile does not contain a sufficient number of reliable values. In this case it is better to disregard the analysis of this tile, which are likely not correct. If too many tiles cannot be evaluated, the analysis of the two-dimensional map will generally not lead to useful results. It is then better not to generate any analysis result.

Preferably, analysis results of small tiles are weighted with a weighting factor. This allows to give smaller tiles a lower weight, which could otherwise negatively affect the analysis results.

Advantageously, the step of segmenting the two-dimensional map into a plurality of tiles is repeated to generate a horizontally and/or vertically shifted grid of tiles. This ensures that also smaller contiguous violations that lie across tile borders are reliably detected.

### BRIEF DESCRIPTION OF THE DRAWINGS

For a better understanding the invention shall now be explained in more detail in the following description with reference to the figures. It is understood that the invention is not limited to this exemplary embodiment and that specified features can also expediently be combined and/or modified without departing from the scope of the present invention as defined in the appended claims. In the figures:

FIG. 1 shows the left image of a stereoscopic image pair;

FIG. 2 shows the right image of the stereoscopic image pair;

FIG. 3 depicts a disparity map associated to the stereoscopic image pair of FIG. 1;

FIG. 4 depicts the disparity map of FIG. 3 split into a plurality of tiles;

FIG. 5 schematically illustrates a method according to the invention for analyzing stereoscopic or multi-view images; and

FIG. 6 schematically depicts an apparatus configured to perform the method according to the invention.

### DETAILED DESCRIPTION OF PREFERED EMBODIMENTS

In the following the invention will be explained with regard to the analysis of a disparity map associated to a stereoscopic image pair. Of course, the invention is not limited to stereoscopic images. It is just as well applicable to multi-view images. Furthermore, the images themselves or other maps derived from the images or associated to the images apart from the disparity map can likewise be analyzed.

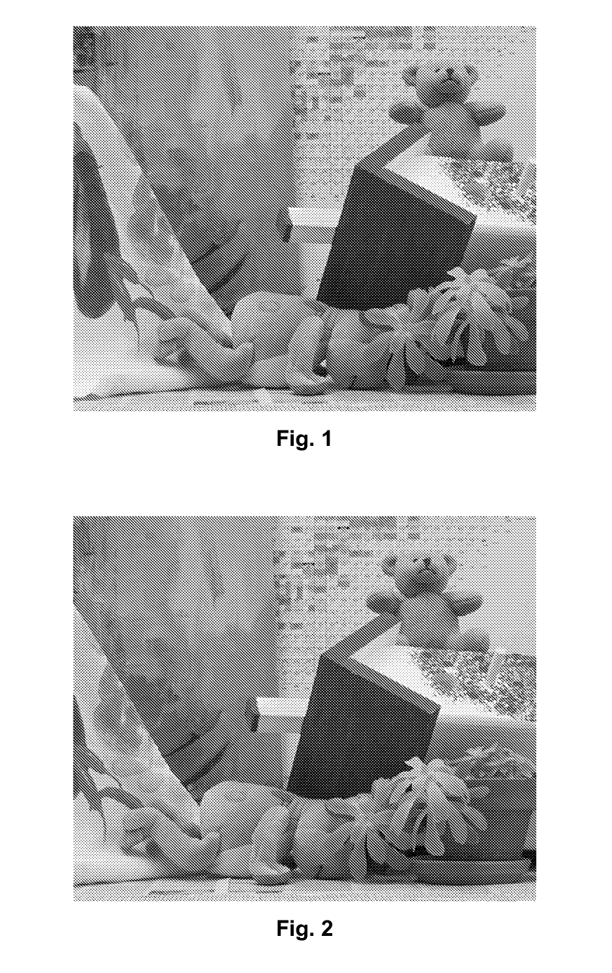

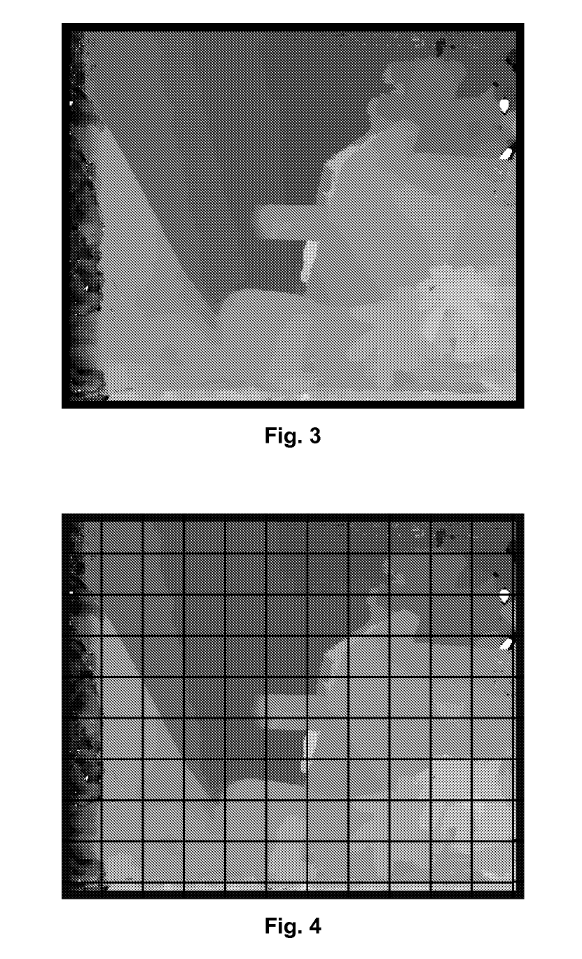

FIG. 1 shows the left image of a stereoscopic image pair, FIG. 2 depicts the corresponding right image. An associated disparity map is shown in FIG. 3. The disparity map of FIG. 3 split into a plurality of tiles is depicted in FIG. 4.

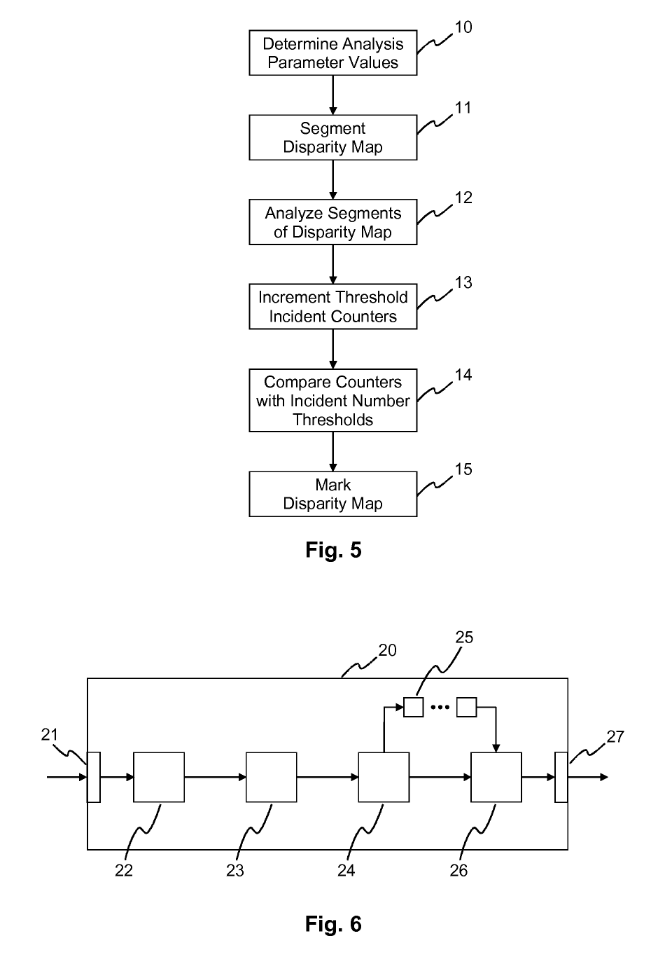

FIG. 5 schematically illustrates a method according to the invention for analyzing stereoscopic or multi-view images. In a first step 10, based on the downscaling factor that was used to downscale the stereoscopic input images prior to the disparity estimation, adequate values for the analysis parameters are determined. Two main parameters are the horizontal tile size t_hor and the vertical tile size t_ver. Other analysis parameters will be summarized further down below.

Subsequently the disparity map is evenly segmented 11 into tiles of the size defined by the horizontal tile size t_hor and the vertical tile size t_ver, which results in the creation of a tile grid. In general, the tiles have a uniform size, but there is one exception. If the width m_width of the disparity map is not a multiple of the horizontal tile size t_hor or if the height m_height of the disparity map is not a multiple of the vertical tile size t_ver, smaller tiles at the border of the disparity map are needed to achieve a full coverage of the entire disparity map. These smaller tiles are treated separately, as their analysis parameters are preferably adapted to their smaller size. Optionally, a lower weight is given to their results in the overall evaluation. The disparity map is segmented into a number N_row of rows and a number N_col of columns, where N_row=ceil(m_height/t_ver) and N_col=ceil(m_width/t_hor). Each row consists of N_col adjacent tiles and each column of N_row adjacent tiles.

Once the tile grid has been created 11, for each tile an analysis is performed 12. In accordance with a simple solutions, the number N_i of incidents is counted. Depending on the analysis criterion, an incident occurs if the disparity value is equal to or greater than a threshold T_i or equal to or smaller than the threshold T_i. One option is to take only the disparity values into account that have a confidence value, which is a well known reliability measure, that is equal to or greater than a threshold T_CV. Even multiple thresholds T_i1, T_i2, . . . can be used for the incidents. This allows for having severity levels for the incidents. For each threshold T_iX the number N_i1, N_i2, . . . of incidents is counted 13 separately. If a comparison 14 yields that the number N_i or N_iX of incidents is equal to or greater than a corresponding threshold T_Ni or T_NiX, a threshold incident for this specific threshold is indicated 15. The threshold T_Ni or T_NiX guarantees that only a sufficient number of incidents triggers a threshold incident.

In accordance with a more advanced solution, a histogram-based analysis is performed. First a histogram is built from all disparity values that have a confidence value that is equal or greater than a threshold T_CV. Then outliers are removed. For this purpose the histogram is separated into regions. A new region starts whenever the number of disparity values for a histogram bin is equal to or less than a certain threshold T_bin. Those regions whose bins have only a total number of disparity values below a certain threshold T_N,min are discarded. For the remaining regions the number of incidents is counted as described above.

A successful analysis of a tile returns the above mentioned threshold incidents. An unsuccessful tile analysis returns the status ‘failed’. An analysis can fail, for example, if the total number of disparity values or reliable disparity values within a tile is below a certain threshold T_min.

If there is a threshold incident, in the next step the tile is marked and the corresponding threshold incident counter is incremented 13, e.g. C_NiX=C_NiX+1. Advantageously, there also is a counter C_fail that is incremented if the analysis returns the status ‘failed’.

If the counter C_fail is equal to or greater than a threshold T_fail, it is indicated that the analysis for this disparity map cannot return a valid result. Otherwise, it is indicated that the analysis result is valid.

Finally, the counters for the marked tiles C_Ni (or C_NiX with X=1, 2, . . . ) are compared 14 with the corresponding incident number thresholds T_CNi (or T_CNiX with X=1, 2, . . . ). If at least one of the counters is equal to or higher than the corresponding incident number threshold, the complete map and thus the corresponding stereoscopic image pair is marked 15 as not passing the specific analysis criterion.

Optionally, in order to give smaller tiles a lower weight, their threshold incidents are counted with separate counters, e.g. C_NiX,small. In the above comparing step 15 these separate counters are added to the standard counters C_NiX by calculating C_NiX=C_NiX+floor(C_NiX,small/W_small), where W_small is a weighting factor.

In order to also detect smaller contiguous violations that lie across tile borders, one strategy is to apply one or more iterations with a certain horizontal and vertical offset for the tile grid, e.g. half of the vertical and half of the horizontal tile size. The smaller tiles that are created at the border due to the offset are treated separately as described above.

The analysis parameters can be summarized as follows:

T_i and T_iX: Thresholds used to detect incidents

T_CV: Threshold for the confidence value

T_Ni and T_NiX: Thresholds used to indicate threshold incidents

T_bin: Threshold defining the start of a new histogram region

T_N,min: Threshold for the number of disparity values forming a contiguous histogram region to be taken into account for the analysis

T_min: Threshold for the minimum number of (reliable) disparity values required for a successful tile analysis

T_fail: Threshold for the acceptable number of failed tile analyses

T_CNi and T_CNi: Threshold for the acceptable number of threshold incidents

W_small: Weight for smaller tiles

The analysis parameters are adapted to the tile size.

Furthermore, either the thresholds used to detect incidents or the disparity values are scaled in accordance with the downscaling factor in order to generate scale-invariant results.

FIG. 6 schematically depicts an apparatus 20 configured to perform the method according to the invention. The apparatus 20 includes an input 21 for receiving a disparity map associated to a stereoscopic image pair. A parameter determination unit 22 determines adequate values for the analysis parameters for the disparity map. A segmenter 23 segments the disparity map into a plurality of tiles, which are then analyzed by an analyzer 24. A plurality of threshold incident counters 25 are provided for counting threshold incidents signaled by the analyzer 24. Of course, it is not necessary to implement the threshold incident counters 25 in hardware. They may likewise be realized as variables in software. A comparator 26 compares the incident counter values with corresponding incident number thresholds and marks the disparity map as not passing the specific analysis criterion if at least one of the counters is equal to or higher than the corresponding incident number threshold. The evaluation result determined by the comparator 26 is made available by the apparatus 20 for further handling via an output 27.

What is claimed, is:

1. A method for analyzing stereoscopic or multi-view images, the method comprising the steps of:
retrieving a two-dimensional map associated to the stereoscopic or multi-view images;
segmenting the two-dimensional map into a plurality of tiles;
performing an analysis of the tiles of the two-dimensional map; and
determining an analysis result for the two-dimensional map from results of the analysis of the tiles of the two-dimensional map.

2. The method according to claim 1, wherein the results of the analysis of the tiles of the two-dimensional map are gathered using counters.

3. The method according to claim 1, wherein analysis parameters are determined based on a downscaling factor that was used to downscale the stereoscopic input or multi-view images prior to generating the two-dimensional map.

4. The method according to claim 3, wherein the analysis parameters include at least one of a horizontal tile size, a vertical tile size, and one or more thresholds for detecting or confirming incidents within the tiles.

5. The method according to claim 1, further comprising the steps of:
determining whether the analysis of one or more tiles of the two-dimensional yielded an incident;
comparing the number of tiles for which the analysis yielded an incident with a threshold; and
determining that the stereoscopic or multi-view images do not pass the analysis if the number of tiles for which the analysis yielded an incident exceeds the threshold.

6. The method according to claim 1, further comprising the steps of:
determining whether the analysis of one or more tiles of the two-dimensional map failed;
comparing the number of tiles for which the analysis failed with a threshold; and
determining that the analysis of the two-dimensional map failed if the number of tiles for which the analysis failed exceeds the threshold.

7. The method according to claim 1, wherein analysis results of small tiles are weighted with a weighting factor.

8. The method according to claim 1, wherein a histogram analysis is performed on the tiles.

9. The method according to claim 1, wherein the step of segmenting the two-dimensional map into a plurality of tiles is repeated to generate a horizontally and/or vertically shifted grid of tiles.

10. The method according to claim 1, wherein the two-dimensional map is a disparity map, a confidence map, or one of the stereoscopic or multi-view images or a reduced version thereof.

11. An apparatus for analyzing stereoscopic or multi-view images, wherein the apparatus comprises:
an input for retrieving a two-dimensional map associated to the stereoscopic or multi-view images;
a segmenter for segmenting the two-dimensional map into a plurality of tiles;
an analyzer for performing an analysis of the tiles of the two-dimensional map; and
a comparator for determining an analysis result for the two-dimensional map from results of the analysis of the tiles of the two-dimensional map.
